(19) United States
(12) Patent Application Publication
(10) Pub. No.: US 2009/0003970 A1
(43) Pub. Date: Jan. 1, 2009

(54) Threaded anchor having a head portion comprising a hexagonally configured drive section, and an integral projection having a transverse bore formed therein

(75) Inventor: Richard Griffith, Little Silver, NJ (US)

Correspondence Address: Steven W. Weinrieb;LAW OFFICES OF STEVEN W. WEINRIEB, 8717 Cold Spring Road, Potomac, MD, 20854, US

(73) Assignee: ILLINOIS TOOL WORKS INC.

(21) Appl. No.: 11/819,910

(22) Filed: Jun. 29, 2007

(51) Int. Cl. F16B 25/08

(52) U.S. Cl. 411/485

(57) ABSTRACT

A threaded anchor which comprises a threaded shank portion, a tip portion defined upon one end of the threaded shank portion, and a head portion disposed adjacent to the opposite end of the threaded shank portion. The head portion comprises a hexagonally configured drive section for threadedly driving the threaded anchor into a substrate. An axially extending lug-type projection is integrally connected to the hexagonally configured drive section of the head portion, and a transversely oriented throughbore is defined within the axially extending lug-type projection so as to accommodate any one of a structural or fixture support wire or cable, a power cable, a fiber optic or telephone cable, a turnbuckle wire assembly, a support strap, a safety or guy wires, a tie down wire or cable, and the like.

### FIELD OF THE INVENTION

The present invention relates generally to threaded anchors, and more particularly to a new and improved threaded anchor having a head portion integrally formed upon one end of the threaded anchor, wherein the head portion comprises a hexagonally configured drive section which serves as a drive means for threadedly driving, inserting, and embedding the threaded anchor within a bore which has been pre-drilled into a masonry or concrete substrate or substructure, wherein an axially extending lug-type projection is integrally connected to the hexagonally configured drive section of the head portion, and wherein further, a transversely oriented throughbore is defined within the lug-type projection so as to accommodate structural or fixture support wires or cables, electrical power cables, fiber optic or telephone cables, turnbuckle wire assemblies, support straps, safety or guy wires, tie down wires or cables, threaded support rods, and the like. In this manner, not only can the single, integral, one-piece threaded anchor be rapidly installed within a particular masonry or concrete substrate or substructure, but in addition, the aforenoted cables, wires, straps, or threaded rods can be subsequently inserted into and through the bore, defined within the lug-type projection, and secured to the lug-type projection of the threaded anchor.

### BACKGROUND OF THE INVENTION

Anchors of various different types, for insertion within various different substrates or substructures, are of course well known in various industries. One type of anchor that may be used, for example, in connection with masonry or concrete substrates or substructures is disclosed within U.S. Pat. No. 6,296,433 which issued to Forsell et al. on Oct. 2, 2001. While the anchor disclosed within the aforenoted patent has performed quite satisfactorily, it is noted that this type of anchor is used primarily, for example, for attaching, mounting, connecting, or securing various objects, devices, or articles to or upon the underlying masonry or concrete substrate or substructures as a result of a portion of the particular object, device, or article being effectively interposed between the relatively large diameter head portion of the anchor and the underlying masonry or concrete substrate or substructure, and subsequently, inserting and threadedly engaging the anchor within the underlying masonry or concrete substrate or substructure so as to fixedly embed the anchor within the underlying substrate or substructure. In various industries, however, in a somewhat alternative mode or manner for attaching, mounting, connecting, securing, or supporting objects, devices, or articles with respect to the underlying substrate or substructure, it is often required or desired to in fact be capable of attaching, mounting, connecting, securing, or supporting an object, device, or article directly to the anchor.

For example, in the electrical industry, electrical contractors often need to employ cables, wires, or support rods in order to hang or support lighting fixtures, route electrical power cables, and the like. In the construction industry, acoustical contractors often need to fasten suspension cables, wires, or rods in connection with the installation of acoustical tiles within ceiling grid arrangements. Similarly, in the communications industry, it is often necessary to utilize support wires or cables in order to install and support telephone wires and other communication cables. Yet further, in the heating, ventilation, and air-conditioning (HVAC) industry, it is often necessary to provide support wires or cables in connection with the hanging or suspension of various piping or duct work. Still further, in the sign industry, sign installers need to utilize cables, wires, or rods in connection with the installation and support of fixed signs or in connection with the installation and support of suspended signs. Still yet further, general contractors or rigging contractors often need to secure safety wires or cables, guy wires or cables, tie down wires or cables, and the like, for properly supporting ladders, scaffolding, turnbuckle assemblies used in connection with the mounting and stabilization of installed machinery, and the like. It is to be appreciated, however, that the anchor, as disclosed within the aforenoted patent, does not have the requisite structure that would en-able the same to be readily utilized in connection with the attachment, mounting, connection, securing, or supporting of the various aforenoted wires, cables, or support rods directly to the anchor.

A need therefore exists in the art for a new and improved threaded anchor wherein the anchor may be threadedly engaged within a masonry or concrete substrate or substructure, and wherein, in addition, means are integrally provided upon, for example, the head portion of the threaded anchor so as to facilitate the direct attachment thereto of wires, cables, straps, threaded rods, or the like. In this manner, the threaded anchor can be utilized by various different field installation personnel, workmen, contractors, or the like, in connection with the installation of various different articles, devices, systems, power supplies, machinery, and the like. For example, in the electrical industry, a need exists in the art for a new and improved threaded anchor so as to permit electrical contractors to employ cables, wires, or support rods in order to hang or support lighting fixtures or power supplies, route electrical power cables, and the like. In the construction industry, a need exists in the art for a new and improved threaded anchor so as to permit acoustical contractors to fasten suspension cables, wires, or rods in connection with the installation of acoustical tiles within ceiling grid arrangements. Similarly, in the communications industry, a need exists in the art for a new and improved threaded anchor wherein it is often necessary to utilize support wires or cables in order to install and support telephone wires and other communication cables. Yet further, in the heating, ventilation, and air-conditioning (HVAC) industry, a need exists for a new and improved anchor wherein it is often necessary to provide support wires or cables in connection with the hanging or suspension of various piping or duct work. Still further, in the sign industry, a need exists in the art for a new and improved threaded anchor in view of the fact that sign installers need to utilize cables, wires, or rods in connection with the installation and support of fixed signs or in connection with the installation and support of suspended signs. Still yet further, a need exists in the art for a new and improved threaded anchor so as to permit general contractors or rigging contractors to secure safety wires or cables, guy wires or cables, tie down wires or cables, and the like, for properly supporting ladders, scaffolding, turnbuckle assemblies used in connection with the mounting and stabilization of installed machinery, and the like.

### SUMMARY OF THE INVENTION

The foregoing and other objectives are achieved in accordance with the teachings and principles of the present invention through the provision of a new and improved threaded anchor which comprises a threaded shank portion, having a large diameter thread portion and a small diameter thread portion wherein the plurality of threads comprising the small diameter thread portion are respectively interposed between the plurality of threads comprising the large diameter thread portion, a tip portion defined upon one end of the threaded shank portion and adapted to be inserted into a bore which has been pre-drilled into a masonry or concrete substrate or substructure, and a head portion disposed adjacent to the opposite end of the threaded shank portion. The head portion comprises a hexagonally configured drive section which serves as a drive means for threadedly driving, inserting, and embedding the threaded anchor within the pre-drilled bore defined within the masonry or concrete substrate or substructure, and an axially extending lug-type projection is integrally connected to the hexagonally configured drive section of the head portion. A transversely oriented throughbore is defined within the axially extending lug-type projection so as to accommodate structural or fixture support wires or cables, electrical power cables, fiber optic or telephone cables, turnbuckle wire assemblies, support straps, safety or guy wires, tie down wires or cables, and the like, and in this manner, not only can the single, integral, one-piece threaded anchor be rapidly installed within a particular masonry or concrete substrate or substructure, but in addition, the aforenoted cables, wires, straps, rods, or the like, can subsequently be easily and readily inserted into and through the bore, defined within the lug-type projection, so as to be secured to the lug-type projection of the threaded anchor.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a side elevational view of a first embodiment of a new and improved threaded anchor as constructed in accordance with the principles and teachings of the present invention and showing the cooperative parts thereof; and

FIG. 2 is a side perspective view, similar to that of FIG. 1, showing, however, a second embodiment of a new and improved threaded anchor as constructed in accordance with the principles and teachings of the present invention and showing the cooperative parts thereof.

### DETAILED DESCRIPTION OF THE ILLUSTRATED EMBODIMENTS

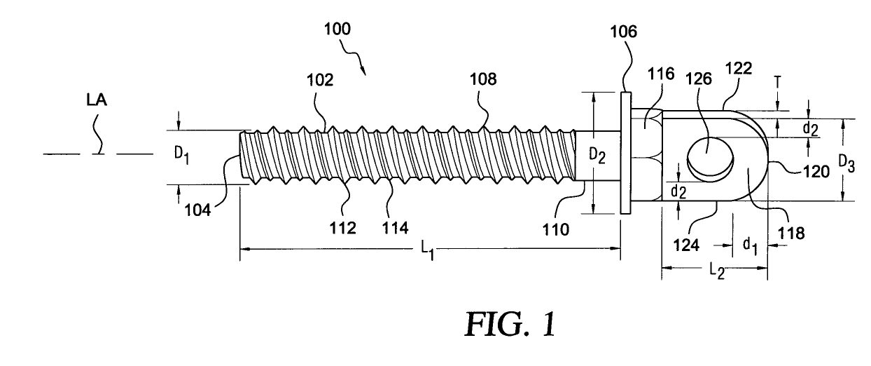

Referring now to the drawings, and more particularly to FIG. 1 thereof, a first embodiment of a new and improved threaded anchor, as constructed in accordance with the principles and teachings of the present invention and showing the cooperative parts thereof, is disclosed and is generally indicated by the reference character 100. More particularly, it is seen that the first embodiment of the new and improved threaded anchor 100, as constructed in accordance with the principles and teachings of the present invention, is seen to comprise a shank portion 102 which has a tip portion 104 formed upon a first axial end portion thereof, and a flanged head portion 106 formed upon a second opposite axial end portion thereof. The shank portion 102 of the threaded anchor 100 is seen to be threaded over a substantial axial extent thereof, wherein the threaded portion 108 of the threaded anchor 100 is seen to commence at substantially the first axial end tip portion 104 of the threaded anchor 100, and to extend axially toward the second axial end flanged head portion 106 of the threaded anchor 100 so as to terminate at an axial position adjacent the flanged head portion 106 of the threaded anchor 100, thereby defining a non-threaded section 110 of the shank portion 102. The shank portion 102 of the threaded anchor 100 has an axial length L₁ of approximately three inches (3.00″), and a diametrical extent D₁ of approximately three-eighths of an inch (0.375″). In addition, it is also seen that the threaded portion 108 of the threaded anchor 100 comprises a large diameter thread portion 112, and a small diameter thread portion 114, wherein it is seen that the individual threads of the small diameter thread portion 114 are interposed between adjacent or successive ones of the individual threads of the large diameter thread portion 112, with the pitch or the distance defined between successive ones of the individual threads of the large diameter thread portion 112 being equal to the pitch or the distance defined between successive ones of the individual threads of the small diameter thread portion 114. It is also noted that the threads of the large diameter thread portion 112 and the threads of the small diameter thread portion 114 are self-tapping threads for performing self-tapping operations within the substrate.

Continuing further, it is also seen that the flanged head portion 106 of the threaded anchor 100 has a section 116 which is integrally formed therewith such that the external periphery of the section 116 has a cross-sectional geometrical configuration which comprises, for example, a hexagon. In this manner, the hexagonally-configured section 116 of the flanged head portion 106 of the threaded anchor 100 may be inserted within, for example, the socket portion of a driving tool so as to serve as a drive means for enabling the threaded anchor 100 to be threadedly driven into and secured within, for example, a pre-drilled bore hole defined within, for example, a masonry or concrete substrate or substructure. The flanged head portion 106 of the threaded anchor 100 may have a diametrical extent D₂ of, for example, approximately seven-eighths of an inch (0.875″), and the hexagonally configured drive section 116 of the flanged head portion 106 of the threaded anchor 100 may have a diametrical extent D₃ of, for example, approximately five-eighths of an inch (0.625″) as defined between oppositely disposed faces or surface portions of the hexagonally configured drive section 116. Still yet further, and in accordance with one of the unique and novel features of the new and improved threaded anchor 100 of the present invention, it is seen that an axially extending lug member or ear 118 is integrally formed with the hexagonally configured drive section 116 of the flanged head portion 106 of the threaded anchor 100 so as to project axially away from the flanged head portion 106 of the threaded anchor 100.

More particularly, it is seen that the axially extending lug member or ear 118 comprises a substantially flat or planar plate-type structure having a substantially rectangular configuration except that the free or distal end or edge portion of the axially extending lug member or ear 118 is rounded or radiused as at 120. It is also seen that the plane within which the flat or planar plate-type structure, comprising the axially extending lug member or ear 118, is disposed, is coplanar with the longitudinal axis of the threaded anchor 100 as defined around the longitudinal axis LA of the shank portion 102. The axial length L₂ of the lug member or ear 118 is approximately three-quarters of an inch (0.750″), and it is noted that the transverse extent of the lug member or ear 118 is substantially the same as the diametrical extent D₃ of the hexagonally configured drive section 116 of the flanged head portion 106 of the threaded anchor 100 as a result of the upper and lower side edge portions 122,124 of the lug member or ear 118, as viewed in FIG. 1, being effectively seamless partial continuations of the two upper and lower side face or surface portions of the hexagonally configured drive section 116 of the flanged head portion 106 of the threaded anchor 100, also as viewed within FIG. 1, while the thickness T of the lug member or ear 118 is approximately three-sixteenths of an inch (0.1875″).

Continuing still further, and in accordance with another unique and novel feature characteristic of the new and improved threaded anchor 100 constructed in accordance with the principles and teachings of the present invention, it is seen that the lug member or ear 118 is provided with a throughbore, aperture, or hole 126 wherein the axis of the throughbore, aperture, or hole 126 extends substantially perpendicular to the plane of the plate-type structure comprising the lug member or ear 118. The throughbore, aperture, or hole 126 is seen to have a diametrical extent of, for example, approximately nine thirty-seconds of an inch (0.28125″), and it is seen that the extreme right, internal edge portion of the throughbore, aperture, or hole 126 is located a first distance d₁ of, for example, approximately one quarter of an inch (0.250″) from the rounded or radiused edge portion 120 of the lug member or ear 118, while the upper and lower internal edge portions of the throughbore, aperture, or hole 126 are respectively located second distances d₂ of, for example, approximately nine sixty-fourths of an inch (0.141″) from the upper and lower edge portions 122,124 of the lug member or ear 118. As a result of the provision or formation of the throughbore, aperture, or hole 126 within the lug member or ear 118 of the threaded anchor 100, when the threaded anchor 100 is threadedly inserted and fixedly embedded within a pre-drilled bore hole defined or formed within a masonry or concrete substrate or substructure, a suitable wire, cable, rod, strap, or the like, may be inserted within and through the throughbore, aperture, or hole 126 so as to serve various functions within various industries.

More particularly, for example, in the electrical industry, electrical contractors often need to employ cables, wires, or support rods in order to hang or support lighting fixtures, route electrical power cables, and the like. In the construction industry, acoustical contractors often need to fasten suspension cables, wires, or rods in connection with the installation of acoustical tiles within ceiling grid arrangements. Similarly, in the communications industry, it is often necessary to utilize support wires or cables in order to install and support telephone wires and other communication cables. Yet further, in the heating, ventilation, and air-conditioning (HVAC) industry, it is often necessary to provide support wires or cables in connection with the hanging or suspension of various piping or duct work. Still further, in the sign industry, sign installers need to utilize cables, wires, or rods in connection with the installation and support of fixed signs or in connection with the installation and sup-port of suspended signs. Still yet further, general contractors or rigging contractors often need to secure safety wires or cables, guy wires or cables, tie down wires or cables, and the like, for properly supporting ladders, scaffolding, turnbuckle assemblies used in connection with the mounting and stabilization of installed machinery, and the like. Accordingly, by providing the throughbore, aperture, or hole 126 within the axially projecting lug member or ear 118 of the threaded anchor 100, such structure enables the attachment, mounting, connection, securing, or supporting of the various aforenoted wires, cables, or support rods directly to the threaded anchor 100 in connection with the hanging or support of the various article, objects, or the like from or with respect to the substrates or substructures within which the threaded anchor 100 is anchored, affixed, or embedded.

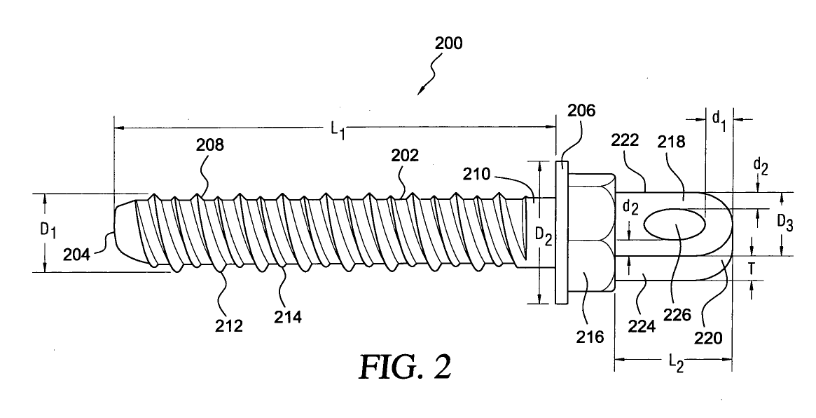

With reference now being made to FIG. 2, a second embodiment of a new and improved threaded anchor, as has also been constructed in accordance with the principles and teachings of the present invention and showing the cooperative parts thereof, is disclosed and is generally indicated by the reference character 200. It is noted that the second embodiment of the new and improved threaded anchor 200, as disclosed within FIG. 2, is substantially similar to the first embodiment of the new and improved threaded anchor 100 as disclosed within FIG. 1, except as will be disclosed and described hereinafter, and therefore a detailed disclosure and description of the same will be omitted herefrom for brevity purposes. It is also noted that those component parts of the second embodiment of the new and improved threaded anchor 200, which correspond to the component parts of the first embodiment of the new and improved threaded anchor 100, will be designated by corresponding reference characters except that they will be within the 200 series. Furthermore, it is noted that the only significant difference between the first and second embodiments of the new and improved threaded anchors 100,200 resides in the fact that the size of the first and second embodiments of the new and improved threaded anchors 100,200 are different as are the various corresponding component parts or structures comprising the first and second embodiments of the new and improved threaded anchors 100,200.

More particularly, for example, it is noted that while the axial length L₁ of the shank portion 202 of the threaded anchor 200 is the same as the axial length L₁ of the shank portion 102 of the threaded anchor 100, the diametrical extent D₁ of the shank portion 202 of the threaded anchor 200 is, for example, one-half inch (0.500″) in lieu of the three-eighths of an inch (0.375″) diametrical extent characteristic of the threaded anchor 100. In addition, it is noted that while the diametrical extent D₂ of the flanged head portion 106 of the threaded anchor 100 is, for example, approximately seven-eighths of an inch (0.875″), the diametrical extent D₂ of the flanged head portion 206 of the threaded anchor 200 is, for example, approximately one and one-eighth inch (1.125″). Yet further, it is seen that the hexagonally configured drive section 216 of the flanged head portion 206 of the threaded anchor 200 may have a diametrical extent D₃ of, for example, three-quarters of an inch (0.750″), as defined between oppositely disposed faces or surface portions of the hexagonally configured drive section 216, as opposed to the diametrical extent D₃ of, for example, five-eighths of an inch (0.625″) as defined between the oppositely disposed faces or surface portions of the hexagonally configured drive section 116 of the threaded anchor 100. In a similar manner, the axial extent or length dimension L₂ of the lug member or ear 218 of the threaded anchor 200 is, for example, approximately eight-tenths of an inch (0.800″), as opposed to the axial extent or length dimension L₂ of, for example, three-quarters of an inch (0.750″) which is characteristic of the lug member or ear 118 of the threaded anchor 100, and in addition, the thickness dimension T of the lug member or ear 218 of the threaded anchor 200 is, for example, approximately one-quarter of an inch (0.250″) as opposed to the thickness dimension T of the lug member or ear 118 of the threaded anchor 100 which is, for example, approximately three-sixteenths of an inch (0.1875″).

In a still similar manner, it is lastly noted that the throughbore, aperture, or hole 226 defined within the lug member or ear 218 of the threaded anchor 200 has a diametrical extent of, for example, approximately thirteen thirty-seconds of an inch (0.40625″) as opposed to the diametrical extent of, for example, approximately nine thirty-seconds of an inch (0.28125″) as is characteristic of the throughbore, aperture, or hole 126 defined within the lug member or ear 118 of the threaded anchor 100. It is also noted that the extreme right, internal edge portion of the throughbore, aperture, or hole 226 is located a first distance d₁ of, for example, approximately one quarter of an inch (0.250″) from the rounded or radiused edge portion 220 of the lug member or ear 218, which is substantially similar to the location of the through-bore, aperture, or hole 126 with respect to the radiused or rounded edge portion 120 of the lug member or ear 118, however, the upper and lower internal edge portions of the throughbore, aperture, or hole 226 are respectively located second distances d₂ of, for example, approximately eleven sixty-fourths of an inch (0.172″) from the upper and lower edge portions 222,224 of the lug member or ear 218 as opposed to the aforenoted locations of the upper and lower internal edge portions of the throughbore, aperture, or hole 126 with respect to the upper and lower edge portions 122,124 of the lug member or ear 118 which were approximately nine sixty-fourths of an inch (0.141″).

Thus, it may be seen that in accordance with the principles and teachings of the present invention, there has been provided a new and improved threaded anchor which comprises a threaded shank portion, a tip portion defined upon one end of the threaded shank portion and adapted to be inserted into a bore which has been pre-drilled into a masonry or concrete substrate or substructure, and a head portion disposed adjacent to the opposite end of the threaded shank portion. The head portion comprises a hexagonally configured drive section so as to serve as a drive means for threadedly driving, inserting, and embedding the threaded anchor within the pre-drilled bore defined within the masonry or concrete substrate or substructure, and an axially extending lug-type projection is integrally connected to the hexagonally configured drive section of the head portion. A transversely oriented throughbore is defined within the axially extending lug-type projection so as to accommodate structural or fixture support wires or cables, electrical power cables, fiber optic or telephone cables, turnbuckle wire assemblies, support straps, safety or guy wires, tie down wires or cables, and the like, and in this manner, not only can the single, integral, one-piece threaded anchor be rapidly installed within a particular masonry or concrete substrate or substructure, but in addition, the aforenoted cables, wires, straps, rods, or the like, can subsequently be easily and readily inserted into and through the bore, defined within the lug-type projection, so as to be directly secured to the threaded anchor.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A threaded anchor, comprising:
a shank portion defined around a longitudinal axis;
a tip portion formed upon a first end portion of said shank portion;
a head portion formed upon a second opposite end portion of said shank portion;
thread means, defined upon said shank portion so as to form a threaded portion which is interposed between said tip and head portions of said threaded anchor, for permitting said threaded anchor to be threadedly engaged within a substrate;
drive means defined upon said head portion for facilitating the threaded engagement of said threaded anchor into the substrate;
a lug member integrally formed upon said head portion; and
an aperture defined within said lug member for accommodating an elongated member therethrough by means of which objects can be secured to said threaded anchor.

2. The threaded anchor as set forth in claim 1, wherein:
said head portion of said threaded anchor has external surface portions which together define a hexagonally configured cross-sectional configuration so as to define said drive means.

3. The threaded anchor as set forth in claim 2, wherein:
said lug member extends axially away from said head portion.

4. The threaded anchor as set forth in claim 3, wherein:
said lug member comprises a substantially flat plate planar structure which is disposed within a plane which is oriented so as to be substantially coplanar with said longitudinal axis of said shank portion of said threaded anchor.

5. The threaded anchor as set forth in claim 4, wherein:
said hexagonally configured external surface portions comprise six surface portions; and
said lug member comprises two oppositely disposed side surface portions which are integral extensions of two of said six surface portions of said hexagonally configured head portion.

6. The threaded anchor as set forth in claim 4, wherein:
said aperture defined within said lug member is defined around an axis which is disposed substantially perpendicular to said plane within which said lug member, comprising said flat plate planar structure, is disposed.

7. The threaded anchor as set forth in claim 6, wherein:
said aperture is defined within a substantially central region of said lug member.

8. The threaded anchor as set forth in claim 1, wherein:
said threaded portion of said threaded anchor comprises a large diameter thread portion and a small diameter thread portion.

9. The threaded anchor as set forth in claim 8, wherein:
threads of said large diameter thread portion and threads of said small diameter thread portion are self-tapping threads for performing self-tapping operations within the substrate.

10. The threaded anchor as set forth in claim 8, wherein:
successive ones of said threads of said large diameter thread portion and successive ones of said threads of said small diameter thread portion are respectively interposed between successive ones of said threads of said small diameter thread portion and between successive ones of said threads of said large diameter thread portion.

11. A threaded anchor, comprising:
a shank portion defined around a longitudinal axis;
a tip portion formed upon a first end portion of said shank portion;
a head portion formed upon a second opposite end portion of said shank portion, said head portion having a substantially hexagonally configured external cross-sectional configuration so as to define drive means for facilitating the threaded engagement of said threaded anchor into a substrate;
thread means, defined upon said shank portion so as to form a threaded portion which is interposed between said tip and head portions of said threaded anchor, for permitting said threaded anchor to be threadedly engaged within the substrate;
a lug member integrally connected to said head portion and extending outwardly from said drive means of said head portion; and
an aperture defined within said lug member for accommodating an elongated member therethrough by means of which objects can be secured to said threaded anchor.

12. The threaded anchor as set forth in claim 11, wherein:
said lug member extends axially away from said head portion.

13. The threaded anchor as set forth in claim 12, wherein:
said lug member comprises a substantially flat plate planar structure which is disposed within a plane which is oriented so as to be substantially coplanar with said longitudinal axis of said shank portion of said threaded anchor.

14. The threaded anchor as set forth in claim 13, wherein:
said hexagonally configured external surface portions comprise six surface portions; and
said lug member comprises two oppositely disposed side surface portions which are integral extensions of two of said six surface portions of said hexagonally configured head portion.

15. The threaded anchor as set forth in claim 13, wherein:
said aperture defined within said lug member is defined around an axis which is disposed substantially perpendicular to said plane within which said lug member, comprising said flat plate planar structure, is disposed.

16. The threaded anchor as set forth in claim 15, wherein:
said aperture is defined within a substantially central region of said lug member.

17. The threaded anchor as set forth in claim 11, wherein:
said threaded portion of said threaded anchor comprises a large diameter thread portion and a small diameter thread portion.

18. The threaded anchor as set forth in claim 17, wherein:
threads of said large diameter thread portion and threads of said small diameter thread portion are self-tapping threads for performing self-tapping operations within the substrate.

19. The threaded anchor as set forth in claim 17, wherein:
successive ones of said threads of said large diameter thread portion and successive ones of said threads of said small diameter thread portion are respectively interposed between successive ones of said threads of said small diameter thread portion and between successive ones of said threads of said large diameter thread portion.
